(19) United States
(12) Patent Application Publication
(10) Pub. No.: US 2013/0113817 A1
(43) Pub. Date: May 9, 2013

(54) DISPLAY APPARATUS AND CONTROL METHOD THEREOF

(71) Applicant: Young-dae KIM, Suwon-si (KR)

(72) Inventor: Young-dae KIM, Suwon-si (KR)

(73) Assignee: SAMSUNG ELECTRONICS CO., LTD., Suwon-si (KR)

(21) Appl. No.: 13/555,736

(22) Filed: Jul. 23, 2012

(30) Foreign Application Priority Data
Nov. 8, 2011 (KR) 10-2011-0115781

(51) Int. Cl. G09G 5/02

(52) U.S. Cl. 345/589

(57) ABSTRACT

A display apparatus and a control method thereof are provided. The display apparatus including: an image receiver which receives an image signal from an external image source; an image processor which processes the image signal; a display unit which displays an image processed by the image processor; and a controller which extracts color information of the image and adjusts a color of an area complementary to a predetermined area with respect to a color of the predetermined area if a degree of change of a color level in the predetermined area of the image is equal to or less than a threshold value. Accordingly, a hue felt by a viewer is maintained by adjusting a color of an area complementary to another area of a displayed image with respect to a color of the other area, for which a gain adjustment is not available, of the displayed image.

### CROSS-REFERENCE TO RELATED APPLICATION

This application claims priority from Korean Patent Application No. 10-2011-0115781, filed on Nov. 8, 2011 in the Korean Intellectual Property Office, the disclosure of which is incorporated herein by reference.

### BACKGROUND

1. Field

Apparatuses and methods consistent with the exemplary embodiments relate to a display apparatus and a control method thereof, and more particularly, to a display apparatus and a control method thereof which adjusts color for improving a hue felt by a viewer.

2. Description of the Related Art

A display apparatus processes an image signal which is provided by an input source, into a displayable form, and displays the processed image signal for a user. The display apparatus may include a television (TV), a monitor, a portable media player (PMP), etc.

With various contents and the development of display technology, the display apparatus is required to maintain a consistent hue which is felt by a user through a screen to thereby effectively and clearly provide visual information. However, human eyes may not feel the hue as displayed on the display apparatus if they view the same color for a long time.

A related art display apparatus may adjust the hue by adjusting a gain of three basic red, green, and blue (RGB) light sources. However, adjustment of the hue by adjusting the particular gain or more is not available due to systematical restriction. Accordingly, in connection with the color displayed in a particular area of a screen, if at least one of the levels of the RGB light sources is close to the maximum value which may be displayed through the adjustment of the gain, the gain cannot be adjusted further and thus adjustment of the hue is not easy.

### SUMMARY

Accordingly, one or more exemplary embodiments provide a display apparatus and a control method thereof which adjusts a color of an area of a displayed image complementary with respect to a color of another area of the displayed image, for which a gain adjustment is not available, to thereby consistently maintain a hue felt by a viewer.

The foregoing and/or other aspects may be achieved by providing a display apparatus including: an image receiver which receives an image signal from an external image source; an image processor which processes the image signal; a display unit which displays thereon an image processed by the image processor; and a controller which extracts color information of the image and adjusts a color of an area complementary with respect to a color of a predetermined area if a degree of change of a color level in the predetermined area of the image is a threshold value or less.

The display apparatus may further include a storage unit which stores therein the color information, and the color information may include information on a coordinate of each color and information on a coordinate of a complementary color of each color in an RGB color coordinate.

The controller may adjust the color of the area complementary for a predetermined area to a color of a coordinate shifted to a complementary area of the color coordinate.

The controller may adjust the color of the area complementary to the predetermined area if the predetermined area is a predetermined size or more.

The controller may adjust the color of the area complementary to the predetermined area if the area complementary to the predetermined area is at a predetermined distance from the predetermined area in the image.

The controller may adjust the color of the area complementary to the predetermined area if the level of the color of the predetermined area is maintained at the maximum level for a predetermined time.

The foregoing and/or other aspects may be achieved by providing a control method of a display apparatus, the control method including: receiving an image signal from an external image source; processing the image signal; displaying the processed image; extracting color information of the image; and adjusting a color of an area complementary with respect to a color of a predetermined area if a degree of change of the color level of the predetermined area in the image is a threshold value or less.

The control method may further include storing the color information, and the color information may include information on each color and information on a coordinate of a complementary color of each color in an RGB color coordinate.

The adjusting the color may include adjusting the color of the area complementary to the predetermined area to a color of a coordinate shifted to a complementary area of the color coordinate.

The control method may further include determining whether the predetermined area is a predetermined size or more, and the adjusting the color may include adjusting the color of the area complementary to the predetermined area if the predetermined area is a predetermined size or more.

The control method may further include determining whether the area complementary to the predetermined area is at a predetermined distance from the predetermined area in the image, and the adjusting the color may include adjusting the color of the area complementary to the predetermined area if the distance from the predetermined area to the complementary area is the predetermined distance.

The adjusting the color may include adjusting the color of the area complementary to the predetermined area if the level of the color of the predetermined area is maintained at the maximum level for a predetermined time.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a control block diagram of a display apparatus according to an exemplary embodiment;

FIG. 2 illustrates an adjustment of color coordinates of a complementary color;

FIG. 3 illustrates a color adjustment for an area which has a complementary color according to a size of a predetermined area;

FIG. 4 illustrates a color adjustment according to a distance of an area which has a complementary color for a predetermined area;

FIG. 5 illustrates a color adjustment for an area which has a complementary color according to a color level of a predetermined area; and

FIG. 6 is a control flowchart of the display apparatus according to an exemplary embodiment.

### DETAILED DESCRIPTION OF THE EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

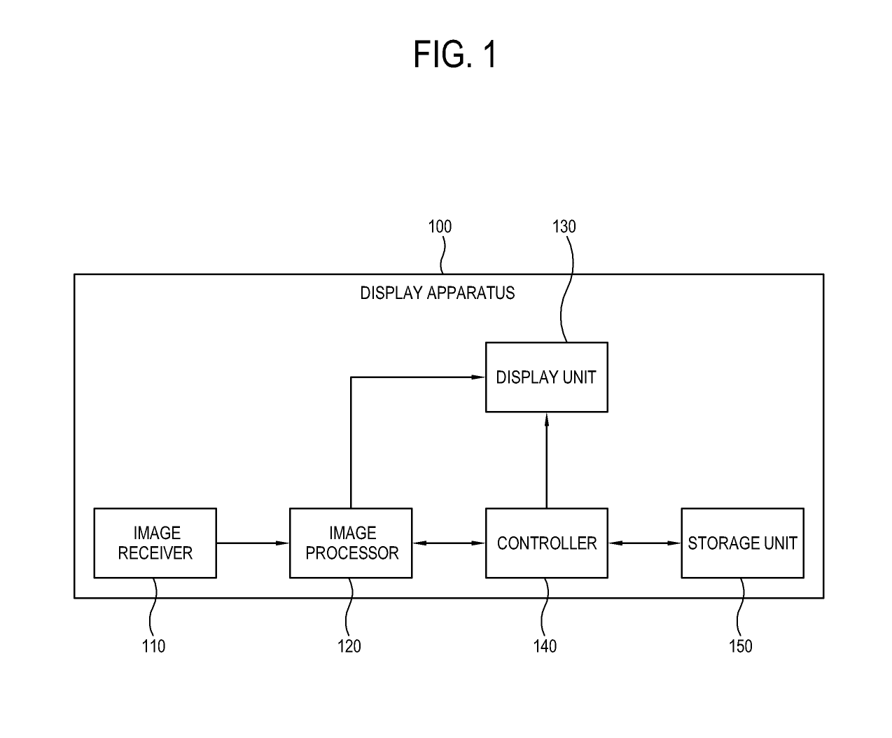

FIG. 1 is a control block diagram of a display apparatus 100 according to an exemplary embodiment.

As shown therein, a display apparatus 100 according to the present exemplary embodiment includes an image receiver 110, an image processor 120, a display unit 130 and a controller 140. The display apparatus 100 may receive an image signal from an external source and display the image signal thereon. The display apparatus 100 may include a monitor, a TV, etc, but not limited thereto.

The image receiver 110 receives an image signal from an external image source. The image receiver 110 receives an image signal including contents from an external image supply source (not shown). The image supply source may vary and receive an image signal from a computer main body which generates and provides an image signal locally with a central processing unit (CPU) and a graphic card, a server which provides an image signal in a network, a transmitter of a broadcasting station which transmits a broadcasting signal by airwave or cable and other various image supply sources. The image receiver 110 transmits the received image signal to the image processor 120.

The image processor 120 processes the image signal received by the image receiver 110 to display an image of the image signal on the display unit 130 (to be described later). The image processing operation of the image processor 120 may include decoding, deinterlacing, frame refresh rate converting, and scaling operations, noise-reducing operation for improvement of picture quality, detail enhancing and line scanning operations.

The display unit 130 displays thereon the image processed by the image processor 120. The display unit 130 may include a display panel (not shown) to display an image, and a panel driver (not shown) to display an image on the display panel according to an input image signal. The image which is displayed on the display unit 130 may be formed by the combination of light emitted by each of three basic RGB light sources. Various colors may be displayed in a plurality of pixels as a result of adjustment of RGB levels by adjusting a gain of the RGB light sources.

The controller 140 performs an overall control operation of the display apparatus 100 according to the present exemplary embodiment. The controller 140 may include a control program, a non-volatile memory such as a read only memory (ROM) and a flash memory storing the control program therein, a volatile memory such as a random access memory (RAM) to load at least a part of the stored control program and a microprocessor such as a CPU and a micro control unit (MCU) to execute the loaded control program.

The controller 140 extracts color information of an image displayed on the display unit 130. Different colors may be displayed in a plurality of pixels, and the controller 140 may gather information of colors displayed in all of the pixels and identify the color information of the displayed image.

The color information may include information on each color coordinate in RGB color coordinates. The RGB color coordinates which are explained herein refer to coordinates of RGB levels for color areas which are expressed through the display apparatus 100, and 256 colors will be explained as an example.

The color information may include information on coordinates of colors which are complementary to each color. The complementary colors mean colors which face oppositely to each other in a color wheel, and are expressed as achromatic colors when overlapping each other. For example, a complementary color of red is blue-green, and may be expressed by combining G and B excluding R.

If the degree of change in a color level in a predetermined area of an image displayed on the display unit 130 is a threshold value or less, the controller 140 adjusts a color of an area which has a complementary color to the color in the predetermined area. The predetermined area means a particular area including a plurality of pixels within the image, and the threshold value may mean the amount of change which may be recognized as almost the same color by a viewer even if there is a change in the color level. In this case, the controller 140 may adjust the color of the area complementary to the predetermined area to a color of a coordinate which is shifted to a complementary area of the color coordinates.

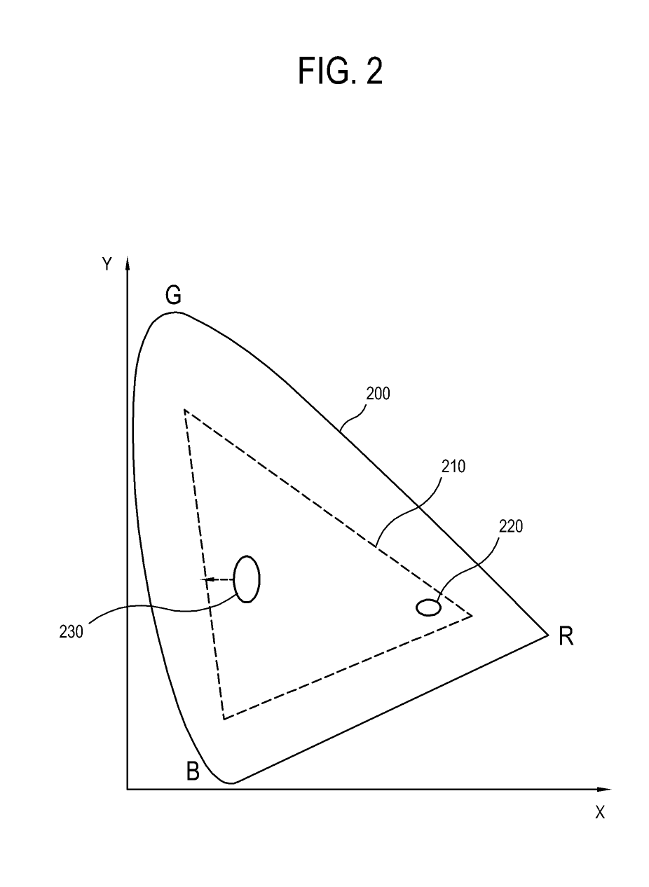

FIG. 2 illustrates a color coordinate 200 and a color coordinate area 210 which is displayable on the display apparatus 100. Referring to FIG. 2, if a predetermined area of an image is maintained as a color 220 close to red for a predetermined time, i.e., if the degree of change of the color level is a threshold value or less, a color 230 in an area complementary to the predetermined area and representing the complementary color of red, i.e., blue-green color, may be adjusted to a color in a color coordinate shifted to the complementary area of the color coordinate.

As shown in FIG. 2, if colors which may be displayed in the display apparatus 100 are limited to colors within the area 210, a color of 220 has an R level that is close to the maximum, and the adjustment of the gain is limited in raising the R level. Accordingly, the color of the area having the color of 230 which is complementary to 220 in an image is adjusted to a color which is shifted to the complementary area in the color coordinate to thereby provide the effect as if the predetermined area having the color of 220 has an R level raised as a result of the complementary color contrast. Thus, the hue which is felt by a viewer may further improve.

The display apparatus 100 may further include a storage unit 150 to store color information therein. The controller 140 may adjust the color of the area complementary to the predetermined area according to the stored color information. The storage unit 150 may store therein an information table which states particular color coordinates and complementary color coordinates.

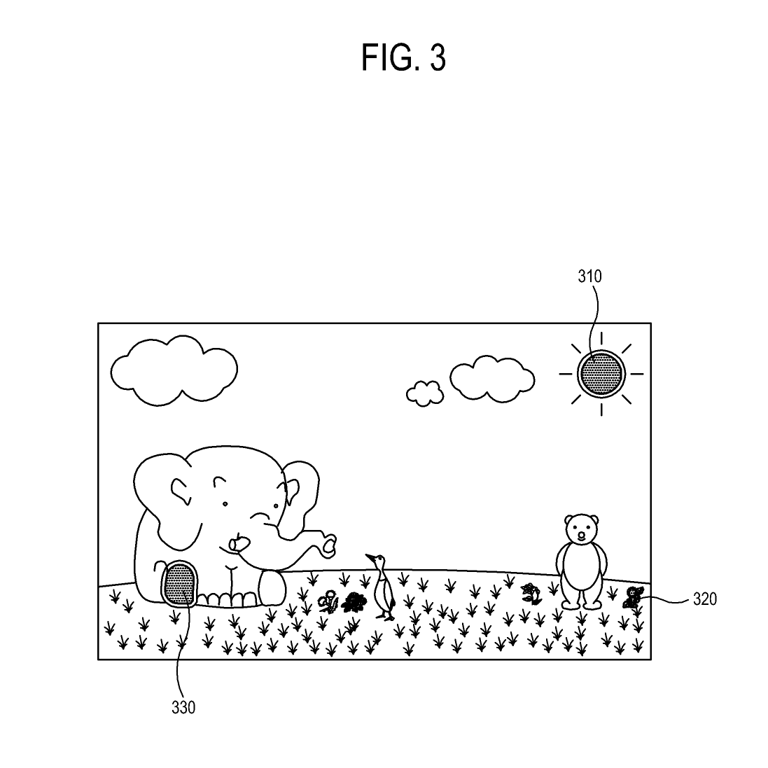

FIG. 3 illustrates a color adjustment of an area complementary to the predetermined area according to a size of the predetermined area.

If a predetermined area in which the degree of change of the color level is a threshold value or less is a predetermined size or more, the controller 140 may adjust the color of the area complementary to the predetermined area. In FIG. 3, if it is assumed that the areas of 310 and 320 have the same color and the area of 330 has a complementary color to the areas of 310 and 320, in a case where the area of 310 having a predetermined size or more maintains a color level within a certain range for a predetermined time, the controller 140 may adjust the color of the area of 330 which is complementary to the area of 310. On the contrary, in the case where the area 320 has a predetermined size or less, the color of an area which is complementary to the area of 320 may not be adjusted even if the degree of change of the color level is maintained as the threshold value or less.

This is based on the rule of thumb that a viewer's line of vision is not concentrated on a small area in an image. The controller 140 may determine the degree of change of the color level for one area in a predetermined size or more where a viewer's line of vision is concentrated on and adjusts the color of another area complementary to the one area.

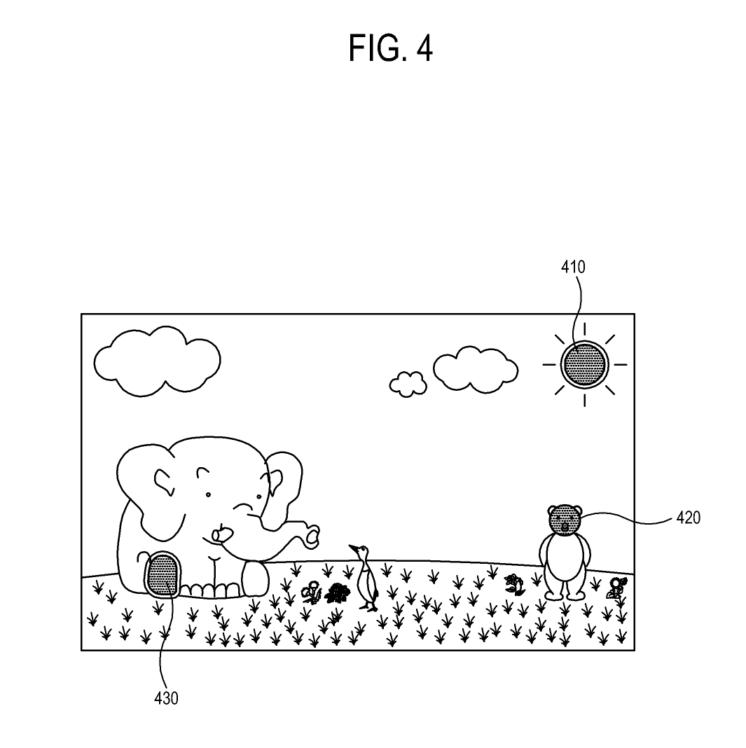

FIG. 4 illustrates color adjustment according to the distance between a predetermined area and an area complementary to the predetermined area.

If an area complementary to the predetermined area is at a predetermined distance from the predetermined area where the degree of change of a color level is a threshold value or less in an image, the controller 140 may adjust the color of the area complementary to the predetermined area. In FIG. 4, if the color of an area 410 and the colors of areas 420 and 430 are presumably complementary, in a case where the degree of change of the color level in the area 410 is a threshold value or less, the color of the area 420 which is at a predetermined distance from the area 410 may be adjusted and the color of the area 430 which is not at the predetermined distance from the area 410 may not be adjusted. This is based on the fact that the complementary color effect is greater in the areas which are in close proximity within the image.

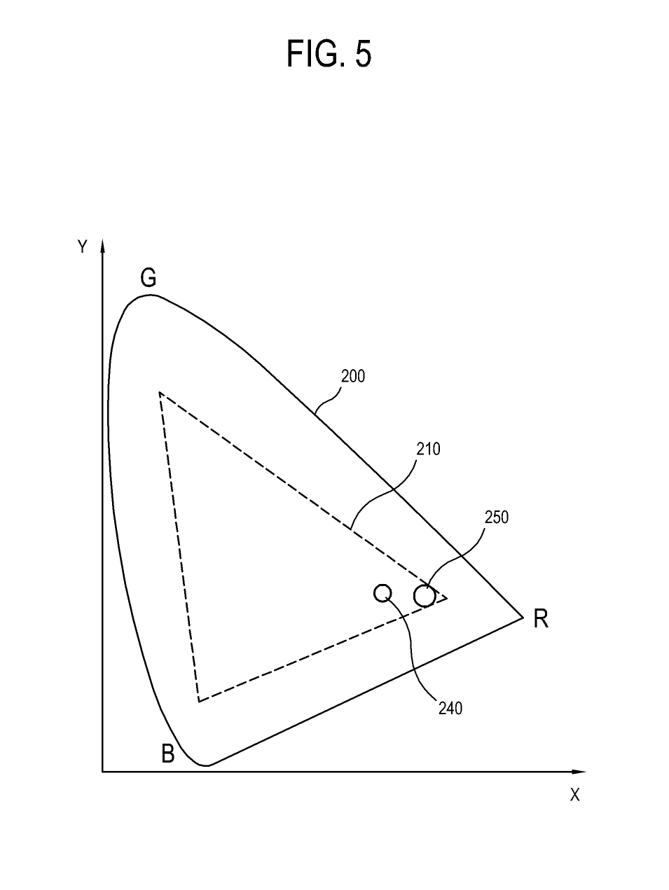

FIG. 5 illustrates color adjustment of an area complementary to the predetermined area according to a color level of the predetermined area.

If a color level of a predetermined area of which the degree of change of the color level is a threshold value or less is maintained at the maximum level for a predetermined time, the controller 140 may adjust the color of an area complementary to the predetermined area. As shown in FIG. 4, if an R level of the color of the predetermined area is close to the maximum value of 255 which may be displayed through gain adjustment (250), the color of the area complementary for predetermined area may be adjusted, since the R level may not be adjusted by the gain adjustment. On the contrary, if the R level may be further raised (operation S240), the gain adjustment may be performed to raise the R level and thus the color of the area complementary to the predetermined area may not be adjusted.

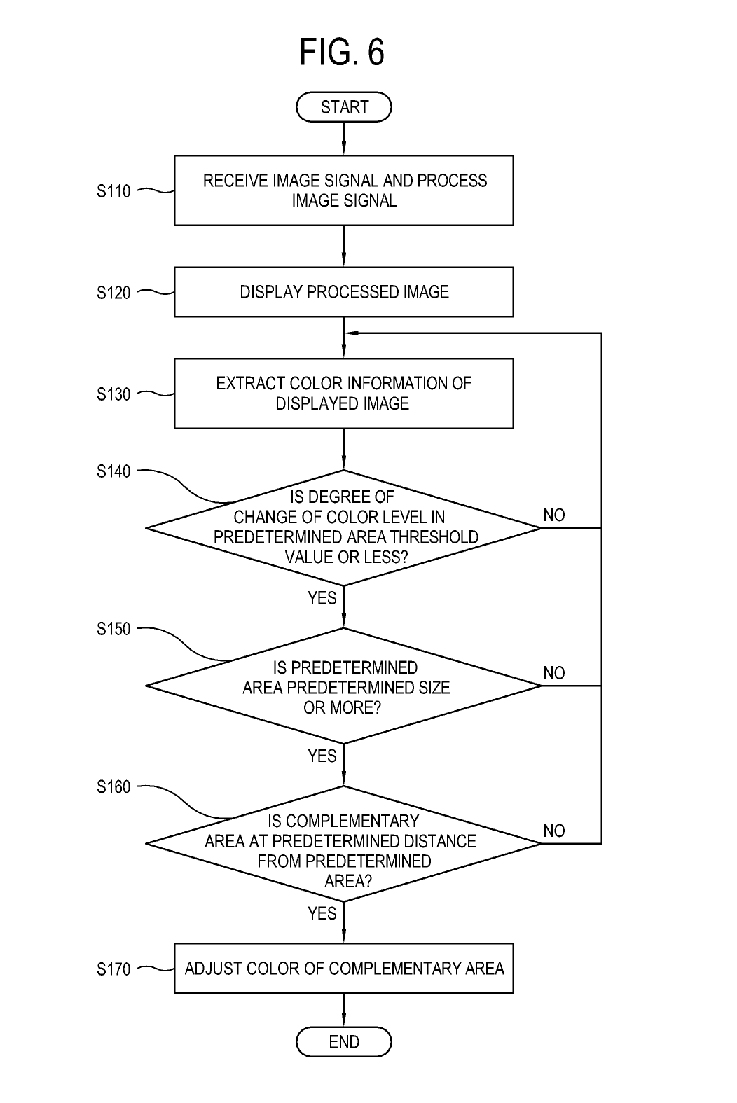

FIG. 6 is a control flowchart of the display apparatus 100 according to an exemplary embodiment.

The display apparatus 100 receives an image signal, processes the received image signal (operation 5110) and displays the processed image (operation S120).

The display apparatus 100 extracts color information of the image (operation S130). The plurality of pixels which is included in the image displayed may display different colors. The display apparatus 100 may identify the color information of the displayed image by gathering the information of the colors displayed in all of the pixels. The color information may include information on the color coordinates of each color and information on the coordinates of the complementary colors of each color in RGB color coordinates.

The display apparatus 100 determines whether the degree of change of the color level in the predetermined area is a threshold value or less (operation S140), and if so may adjust the color of an area complementary to the predetermined area (operation S170). The predetermined area may mean a particular area including a plurality of pixels in the image, and the threshold value may mean the amount of change which may be recognized as almost the same color by a viewer even if there is change in the color level.

The display apparatus 100 may adjust the color of the area complementary to the predetermined area to the color of the coordinate shifted to the complementary area of the color coordinates. This has been described with reference to FIG. 2.

The display apparatus 100 according to the exemplary embodiments may further include an operation of storing the color information, and may adjust the color of the area complementary to the predetermined area according to the stored color information. The stored color information may include coordinate information of a particular color and of a complementary color to the particular color as a table.

The display apparatus 100 may further include an operation of determining whether the predetermined area of which the degree of change of a color level is a threshold value or less is a predetermined size or more (operation S150), and may adjust the color of the area complementary to the predetermined area if the predetermined area is the predetermined size or more (operation S170). This has been described with reference to FIG. 3.

The display apparatus 100 may further include an operation of determining whether the area complementary to the predetermined area is at a predetermined distance from the predetermined area in the image (operation S160), and may adjust the color of the area complementary to the predetermined area (operation S170). This has been described with reference to FIG. 4.

The display apparatus 100 may adjust the color of the area complementary to the predetermined area if the level of the color of the predetermined area is maintained at the maximum level for predetermined time. This has been described with reference to FIG. 5.

The display apparatus 100 may adjust the color of the area complementary to the predetermined area to thereby consistently maintain the hue felt by a viewer even if the color level is not improved through adjustment of gain.

As described above, a display apparatus and a control method thereof according to the exemplary embodiments adjusts a color of an area complementary with respect to a color of another area where a gain adjustment is not available in a displayed image to thereby consistently maintain the hue felt by a viewer.

Although a few exemplary embodiments have been shown and described, it will be appreciated by those skilled in the art that changes may be made in these exemplary embodiments without departing from the principles and spirit of the application, the range of which is defined in the appended claims and their equivalents.

What is claimed is:

1. A display apparatus comprising:
an image receiver which receives an image signal from an external image source;
an image processor which processes the image signal;
a display unit which displays thereon the image processed by the image processor; and
a controller which extracts color information of the image and adjusts a color of an area complementary to a predetermined area with respect to a color of the predetermined area if a degree of change of a color level in the predetermined area of the image is equal to or less than a threshold value.

2. The display apparatus according to claim 1, further comprising a storage unit which stores therein the color information, wherein
the color information comprises information on a coordinate of each color in an RGB color coordinate and information on a coordinate of a complementary color of each color in the RGB color coordinate.

3. The display apparatus according to claim 2, wherein the controller adjusts the color of the area complementary to the predetermined area to a color of a coordinate shifted to a complementary area of the color coordinate.

4. The display apparatus according to claim 1, wherein the controller adjusts the color of the area complementary to the predetermined area if the predetermined area is a predetermined size or more.

5. The display apparatus according to claim 1, wherein the controller adjusts the color of the area complementary to the predetermined area if the area complementary to the predetermined area is at a predetermined distance from the predetermined area in the image.

6. The display apparatus according to claim 1, wherein the controller adjusts the color of the area complementary to the predetermined area if the level of the color of the predetermined area is maintained at a maximum level for a predetermined time.

7. A control method of a display apparatus, the control method comprising:
receiving an image signal from an external image source;
processing the image signal;
displaying the processed image;
extracting color information of the image; and
adjusting a color of an area complementary to a predetermined area with respect to a color of the predetermined area if a degree of change of a color level of the predetermined area in the image is equal to or less than a threshold value.

8. The control method according to claim 7, further comprising storing the color information, wherein
the color information comprises information on a color of each color in an RGB color coordinate and information on a coordinate of a complementary color of each color in the RGB color coordinate.

9. The control method according to claim 8, wherein the adjusting the color comprise adjusting the color of the area complementary to the predetermined area to a color of a coordinate shifted to an complementary area of the color coordinate.

10. The control method according to claim 7, further comprising determining whether the predetermined area is a predetermined size or more, wherein the adjusting the color comprises adjusting the color of the area complementary to the predetermined area if the predetermined area is a predetermined size or more.

11. The control method according to claim 7, further comprising determining whether the area complementary to the predetermined area is at a predetermined distance from the predetermined area in the image, wherein the adjusting the color comprises adjusting the color of the area complementary to the predetermined area if the distance is the predetermined distance.

12. The control method according to claim 7, wherein the adjusting the color comprises adjusting the color of the area complementary to the predetermined area if the level of the color of the predetermined area is maintained at a maximum level for a predetermined time.
